(19) United States
(12) Patent Application Publication
(10) Pub. No.: US 2026/0001077 A1
(43) Pub. Date: Jan. 1, 2026

(54) PNEUMATIC SIPHON VALVES AND REACTION CHAMBERS FOR SAMPLE ANALYSIS

(71) Applicant: VITAL BIOSCIENCES INC., Mississauga (CA)

(72) Inventors: Miguel BARREIROS, Lisboa (PT); David Pena de Sousa SANTOS, Beja (PT); Paul Said Ehrlich PEREZ, Toronto (CA); Fahim MASUM, Toronto (CA); Luis Miguel Marques BARBOSA, Gondomar (PT); Mounir KOUSSA, Kitchener (CA)

(21) Appl. No.: 19/321,941

(22) Filed: Sep. 8, 2025

Related U.S. Application Data
(63) Continuation of application No. PCT/IB2024/052279, filed on Mar. 9, 2024.
(60) Provisional application No. 63/489,420, filed on Mar. 9, 2023.
(60) Provisional application No. 63/489,667, filed on Mar. 10, 2023.

(51) Int. Cl. B01L 3/00

(52) U.S. Cl. CPC B01L 3/502723; B01L 2200/0684; B01L 2300/087; B01L 2400/0409

(57) ABSTRACT

A rotatable device includes a vent port, a siphon and a ballast chamber. The siphon has a crest positioned radially outwards of the vent port with respect to the rotational axis. The ballast chamber has a first outlet connected to the vent port and a second outlet connected to an inlet of the siphon. The first outlet of the ballast chamber is positioned radially inwards of the second outlet of the ballast chamber and radially outwards of the crest of the siphon with respect to the rotational axis. As such, the first outlet of the ballast chamber divides the ballast chamber into an unvented ballast portion radially inwards of the first outlet and a vented ballast portion radially outwards of the first outlet, and thus decouples the pressure change inside the ballast chamber from the radial position of the siphon inlet at the ballast chamber.

### CROSS-REFERENCE TO RELATED APPLICATIONS

The present application claims priority to U.S. Provisional Patent Application No. 63/489,420 filed Mar. 9, 2023 and U.S. Provisional Patent Application No. 63/489,667 filed Mar. 10, 2023. The disclosure of each application is incorporated herein for all purposes by reference in its entirety.

### TECHNICAL FIELD

The present disclosure relates to devices and methods for directing fluid, mixing fluid and/or resuspending reagents in centrifugal microfluidics.

### BACKGROUND

Currently, 70% of all medical decisions rely on lab based diagnostics but today, the diagnostic process is disjointed from how care is delivered. The primary care system requires patients to travel to external phlebotomy sites to draw blood which is sent to labs via courier, and processed overnight. This means that lab results reach health care professionals long after the patient has left. This friction in care delivery and disease management leads to tremendous waste in the healthcare system:
a. Patients often delay getting lab tests or fail to adhere to lab testing, or subsequent care recommendations
b. The gap in the diagnostic process leads to missed tests, missed diagnosis, a lack of intervention, and ultimately poor outcomes
c. Health care professionals waste time tracing lab orders to patient encounter notes. When intervention is needed, more time is wasted in reaching out to patients and driving subsequent steps in the patient's care pathway.

These problems are even more acute when caring for rural populations or patients belonging to groups facing adverse social-determinants of health, where there are many challenges in ensuring successful follow ups from an initial patient encounter.

Several companies have built point-of-care instruments to bridge this divide. However, these instruments are limited to single types of tests and fail to completely meet the workflow needs of primary care providers for a single system that produces simple, comprehensive, and fast test results. A product to meet these needs is currently under development. It achieves this through a highly automated workflow enabled through the use of centrifugal microfluidics discs.

Centrifugal microfluidics are used in clinical chemistry, immunoassays, hematology, medicine, biomedical research and other fields. Many of these applications use an unvented chamber connected to a siphon channel to work as an air pressure-dependent valve. The pressure change in such a valve, however, depends on the radial position of the siphon inlet at the chamber. In addition, many of these applications require stopping the cartridge during certain workflows to accommodate multiple washing requirements. However, existing valve designs, such as conventional pneumatic siphons, simple siphon metering valves and capillary siphon valves, are unsatisfactory for these applications.

Accordingly, there remains a need for improved devices and methods in centrifugal microfluidics.

### SUMMARY

The present disclosure addresses these and other needs in the art by providing (i) a siphon valve structure that decouples the pressure change inside the chamber from the radial position of the siphon inlet at the chamber and/or takes less space on a cartridge, (ii) a reusable siphon valve structure independent of the leftover fluid, and (iii) a centrifugal device and method that can not only hold magnetic particles while washing a reaction chamber from all the unwanted components but also allows these particles to move back into the main reaction chamber and homogenize the mixture.

In an aspect, the present disclosure provides a device rotatable around a rotational axis. The device includes a vent port, a siphon, a ballast chamber, and/or other components disclosed herein (e.g., the U-channel described below) to put a liquid inside the ballast chamber without allowing for the air to escape the ballast chamber. The siphon has a crest positioned radially outwards of the vent port with respect to the rotational axis. The ballast chamber has a first outlet connected to the vent port and a second outlet connected to an inlet of the siphon. The first outlet of the ballast chamber is positioned radially inwards of the second outlet of the ballast chamber and radially outwards of the crest of the siphon with respect to the rotational axis, thereby dividing the ballast chamber into an unvented ballast portion radially inwards of the first outlet and a vented ballast portion radially outwards of the first outlet. In some embodiments, the second outlet of the ballast chamber is formed at or adjacent to a radially outermost location of the ballast chamber.

In some embodiments, the device further includes a first channel connecting the first outlet of the ballast chamber to the vent port, an upstream chamber connected to the ballast chamber, a U-channel connecting the ballast chamber to the upstream chamber, a downstream chamber connected to an outlet of the siphon, or any combination thereof.

In some embodiments, the ballast chamber includes an inlet at the unvented ballast portion, and the upstream chamber is connected to the inlet at the unvented ballast portion of the ballast chamber. In some embodiments, the upstream chamber includes an outlet connected to the ballast chamber, and the crest of the siphon and the vent port are radially inwards of the outlet of the upstream chamber. In some such embodiments, the outlet of the upstream chamber is formed at a radially outermost location of the upstream chamber.

In some embodiments, a volume inside the ballast chamber between a radial position of the first outlet and a radial position of the second outlet is larger than a volume needed for overcoming the crest of the siphon. In some embodiments, the downstream chamber is positioned radially outwards of the ballast chamber.

In some embodiments, the vent port, siphon, ballast chamber, first channel, upstream chamber, U-channel, or any combination thereof are configured to allow initial loading of a fluid by rotating the device at a speed that causes the fluid to fill the ballast chamber and the siphon, forming a first meniscus inside of the ballast chamber that is radially inwards of the first outlet and a second meniscus inside of the siphon that is radially outwards of the crest of the siphon.

In some embodiments, the vent port, siphon, ballast chamber, first channel, upstream chamber, U-channel, or any combination thereof are configured to allow emptying of the upstream chamber by decreasing the speed. Alternatively, in some embodiments, the vent port, siphon, ballast chamber, first channel, upstream chamber, U-channel, or any combination thereof are configured to allow emptying of the upstream chamber by increasing the speed.

In some embodiments, the vent port, siphon, ballast chamber, first channel, upstream chamber, U-channel, or any combination thereof are configured to allow complete emptying of the upstream chamber.

In another aspect, the present disclosure provides a device rotatable around a rotational axis. The device includes a chamber, an appendix and magnetic particles. The appendix includes an entrance connected to the chamber and a trapping zone radially outwards of the entrance with respect to the rotational axis. The magnetic particles are movable between the chamber and the appendix by a magnet, positioning of the chamber relative to the magnet, rotation of the device, or any combination thereof.

In some embodiments, the chamber includes a flexible capping layer responsive to one or more sonification pulses to promote mixing of the magnetic particles with a fluid in the chamber. In some embodiments, the magnetic particles are magnetic nanoparticles.

In a further aspect, the present disclosure provides a method including (A) placing a chamber of a device adjacent to a magnet such that magnetic particles contained in the chamber form a first arrangement. The device includes an appendix having an entrance connected to the chamber and a trapping zone radially outwards of the entrance with respect to a rotational axis of the device. The method also includes (B) rotating the device in a first direction with respect to the magnet to move the magnetic particles into the appendix that is connected to the chamber. The method further includes (C) rotating the device at a speed to flush unbound analytes or nonspecifically bound particles out of the chamber. The rotating (C) causes the magnetic particles to move into the trapping zone and remain in the trapping zone.

In some embodiments, the placing (A) is performed by rotating the device. In some embodiments, the magnet produces a magnetic field that is strongest in a middle portion of the chamber. In some embodiments, the rotating (B) is performed continuously. Alternatively, in some embodiments, the rotating (B) is performed intermittently.

In some embodiments, the method further includes (D) filling, subsequent to the rotating (C), the chamber with a fluid, and (E) rotating the device in a second direction with respect to the magnet to move the magnetic particles from the appendix to the chamber. In some embodiments, the rotating (E) is performed continuously. Alternatively, in some embodiments, the rotating (E) is performed intermittently.

In some embodiments where the chamber includes a flexible capping layer, the method further includes (F) aligning the chamber with a sonicator probe, (G) moving the sonicator probe or the device so that the sonicator probe is in contact with the flexible capping layer, and (H) activating the sonicator probe to deliver one or more pulses to promote mixing of the magnetic particles with the fluid.

In some embodiments, the aligning (F) is achieved by rotating the device. In some embodiments, the aligning (F), moving (G) and activating (H) are performed prior to the placing (A). In some embodiments, the aligning (F), moving (G) and activating (H) are performed subsequent to the rotating (E).

In some embodiments, the method further includes (I) allowing, subsequent to the activating (H), a mixture in the chamber to incubate for a period of time.

The devices, systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the invention. The accompanying drawings are not necessarily to scale. The specific design features of the present invention as disclosed herein, including, for example, specific dimensions, orientations, locations, and shapes will be determined in part by the particular intended application and use environment. In addition, the components illustrated in the figures are combinable in any useful number and combination.

In the drawings:

FIG. 1A is a schematic diagram illustrating a device in accordance with some exemplary embodiments of the present disclosure;

FIG. 1B and 1C are schematic diagrams illustrating a siphon valve structure of the device of FIG. 1A in accordance with some exemplary embodiments of the present disclosure;

FIG. 2A is a schematic diagram illustrating an operational process using the device of FIG. 1A in accordance with some exemplary embodiments of the present disclosure;

FIG. 2B is a schematic diagram illustrating a device in accordance with an alternative exemplary embodiment of the present disclosure;

FIG. 2C is a schematic diagram illustrating a device in accordance with another alternative exemplary embodiment of the present disclosure;

FIG. 3A is an image showing a device in accordance with some exemplary embodiments of the present disclosure;

FIG. 3B is a partially enlarged view of FIG. 3A;

FIG. 3C is a schematic diagram illustrating some component(s) of the device of FIG. 3A in accordance with some exemplary embodiments of the present disclosure;

FIG. 4 is a flow chart illustrating a method in accordance with some exemplary embodiments of the present disclosure;

FIGS. 5A, 5B, 5C and 5D are images collectively illustrating a process performed using the device of FIG. 4A in accordance with some exemplary embodiments of the present disclosure;

FIG. 6A is a schematic diagram illustrating a device (e.g., a disc) in accordance with some exemplary embodiments of the present disclosure;

FIG. 6B is a schematic diagram illustrating a loading process in accordance with some exemplary embodiments of the present disclosure;

FIG. 6C is a schematic diagram illustrating a spinning process in accordance with some exemplary embodiments of the present disclosure;

FIG. 6D is a schematic diagram illustrating a priming process in accordance with some exemplary embodiments of the present disclosure;

FIG. 6E-1 is a schematic diagram illustrating an injection and mixing process in accordance with some exemplary embodiments of the present disclosure;

FIG. 6E-2 is a partially enlarged view of FIG. 6E-1;

FIG. 6F-1 is a schematic diagram illustrating a lyophilized bead reconstitution and pulldown process in accordance with some exemplary embodiments of the present disclosure;

FIG. 6F-2 is a partially enlarged view of FIG. 6F-1;

FIG. 6G-1 is a schematic diagram illustrating a wash process in accordance with some exemplary embodiments of the present disclosure;

FIG. 6G-2 is a partially enlarged view of FIG. 6G-1;

FIG. 6H-1 is a schematic diagram illustrating a reporter lyophilized bead reconstitution and incubation process in accordance with some exemplary embodiments of the present disclosure;

FIG. 6H-2 is a partially enlarged view of FIG. 6H-1;

FIG. 6I-1 is a schematic diagram illustrating a particles pulldown and wash process in accordance with some exemplary embodiments of the present disclosure;

FIG. 6I-2 is a partially enlarged view of FIG. 6I-1;

FIG. 6J is a schematic diagram illustrating a resuspend particles and readout process in accordance with some exemplary embodiments of the present disclosure; and

FIG. 7 is a schematic diagram illustrating a device (e.g., a disc) in accordance with an alternative exemplary embodiment of the present disclosure.

### DETAILED DESCRIPTION

### Volume-Independent Pneumatic Siphon Valve

In microfluidics, many applications use an unvented chamber connected to a siphon channel to work as an air pressure-dependent valve. The pressure change in such a valve, however, depends on the radial position of the siphon inlet at the chamber. In addition, such a valve may require a relatively large amount of space on the cartridge to function properly. The present disclosure addresses these and/or other needs by providing a siphon valve structure that decouples the pressure change inside the chamber from the radial position of the siphon inlet at the chamber and/or takes less space on a cartridge.

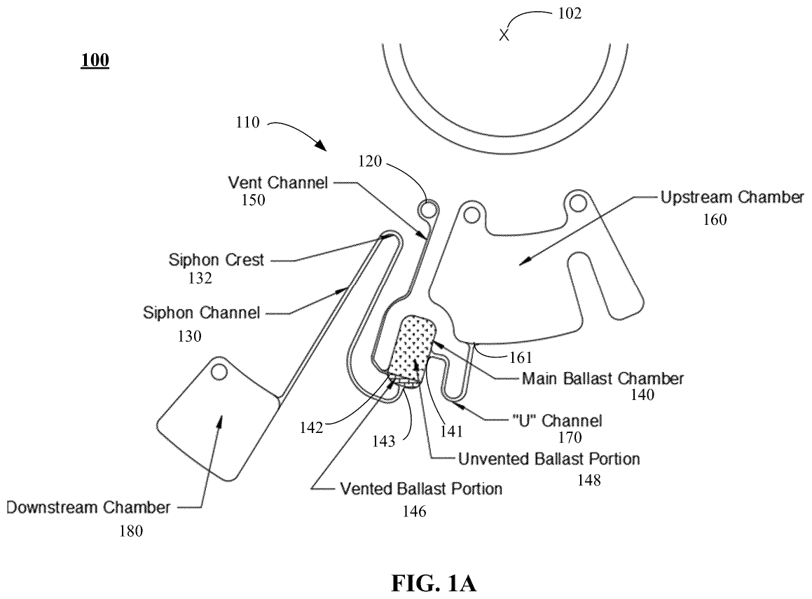

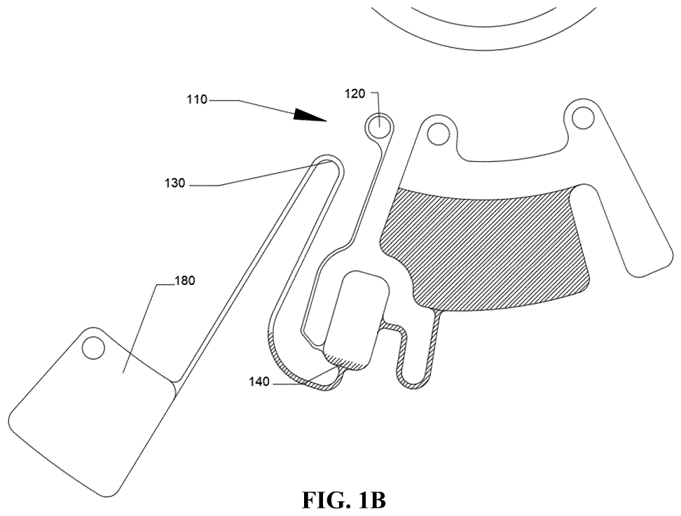

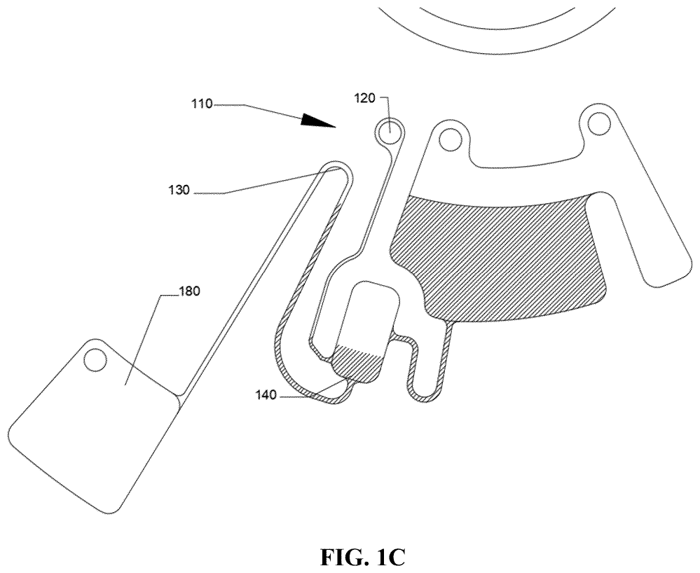

Referring now to the drawings, where like reference numerals indicate like elements throughout, there is shown in FIG. 1A an exemplary device 100 with an exemplary siphon valve structure 110 in accordance with some embodiments of the present disclosure. The device 100 may be a microfluidic disk, cartridge or the like for sample handling or processing. In various embodiments, the device 100 is rotatable around a rotational axis 102.

The siphon valve structure 110 generally includes a vent port 120, a siphon 130 and a ballast chamber 140. The siphon has a crest 132 positioned radially outwards of the vent port with respect to the rotational axis of the device. The ballast chamber has a first outlet 142 connected to the vent port and a second outlet 143 connected to the siphon, e.g., the inlet of the siphon. The first outlet 142 of the ballast chamber is positioned radially inwards of the second outlet 143 but radially outwards of the crest 132 of the siphon. As such, the first outlet 142 divides the ballast chamber into a first portion 146 and a second portion 148. The first portion 146 is the portion that is located radially outwards of the first outlet 142, and the second portion 148 is the portion that is located radially inwards of this outlet.

Because of the presence of the vent port, the position of the meniscus of a fluid will not affect the pressure in the ballast chamber when it is in the first portion of the ballast chamber as illustrated in FIG. 1B. As such, the first portion 146 is referred to herein as a vented portion. However, the position of the meniscus of a fluid will affect the pressure in the ballast chamber when it is in the second portion as the fluid blocks the air pathway to the vent port as illustrated in FIG. 1C. As such, the second portion 148 is referred to herein as an unvented portion. Because the first outlet 142 is radially inward of the second outlet 143, the change of the pressure in the ballast chamber is independent of the position of the second outlet 143, which defines the radial position of the inlet of the siphon. This decouples the pressure change inside the ballast chamber from the radial position of the siphon inlet.

The first and second outlets of the ballast chamber can be formed at any suitable positions as long as the radial position of the first outlet 142 of the ballast chamber is between the second outlet 143 and the crest of the siphon 132. As a non-limiting example, FIG. 1 illustrates that the second outlet 143 of the ballast chamber is formed at or adjacent to a radially outermost location of the ballast chamber.

The device 100 or the siphon valve structure 110 may include additional, optional or alternative components. For instance, in some embodiments, the device 100 or the siphon valve structure 110 includes a channel 150 that connects the first outlet of the ballast chamber to the vent port, an upstream chamber 160 connected to the ballast chamber, a U-channel 170 that connects the ballast chamber to the upstream chamber, a downstream chamber 180 connected to an outlet of the siphon, or any combination thereof. In some embodiments, the U-channel 170 may have an outwards segment and an inwards segment as illustrated in FIGS. 1A-1C and/or other figures disclosed herein.

In some embodiments, the ballast chamber includes an inlet 141 at the unvented ballast portion, and the upstream chamber includes an outlet 161 connected to the inlet 141 of the ballast chamber, for instance, by the U-channel 170. In some embodiments, the outlet of the upstream chamber is formed at a radially outermost location of the upstream chamber. In some embodiments, the crest of the siphon and the vent port are radially inwards of the outlet of the upstream chamber. In some embodiments, the downstream chamber is positioned radially outwards of the ballast chamber. In some embodiments, the ballast chamber and the U-channel are configured such that the volume inside the ballast chamber in an inwards position from the first outlet 142 is larger than a volume needed for overcoming the crest of the siphon, and in some embodiments, may be larger than the volume of the U-channel.

In some embodiments, the vent port, siphon, ballast chamber, first channel, upstream chamber, U-channel, or any combination thereof are configured to allow initial loading of a fluid by rotating the device at a speed that causes the fluid to fill the ballast chamber and the siphon, forming a first meniscus inside of the ballast chamber that is radially inwards of the first outlet 142 and a second meniscus inside of the siphon that is radially outwards of the crest of the siphon 132. In some exemplary embodiments, the vent port, siphon, ballast chamber, first channel, upstream chamber, U-channel, or any combination thereof are configured to allow emptying of the upstream chamber by changing (e.g., decreasing or increasing) the rotational speed. In some embodiments, the vent port, siphon, ballast chamber, first channel, upstream chamber, U-channel, or any combination thereof are configured to allow complete emptying of the upstream chamber by changing the rotational speed.

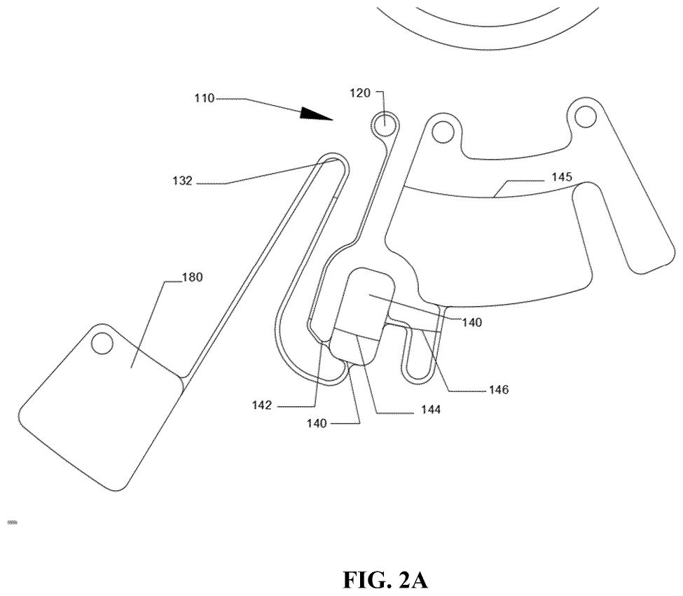

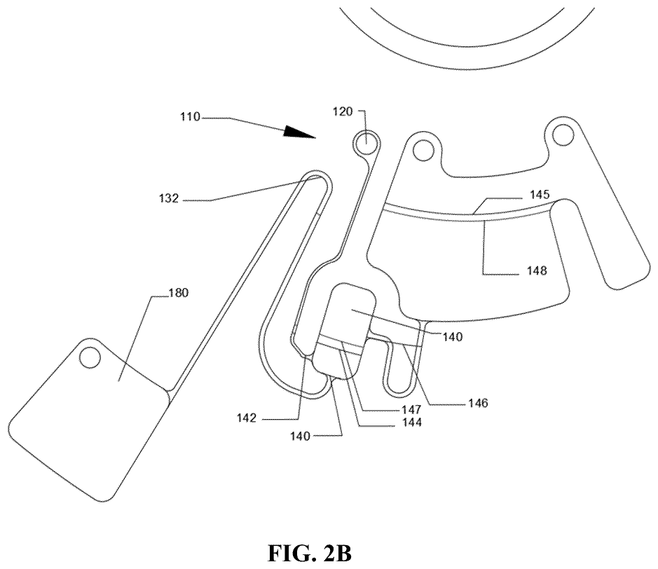

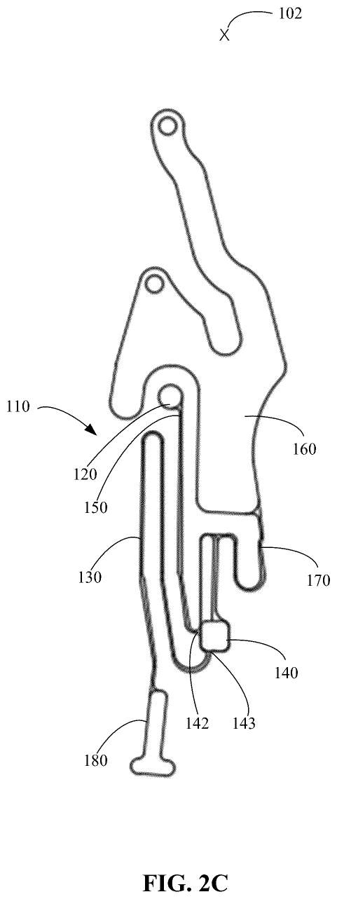

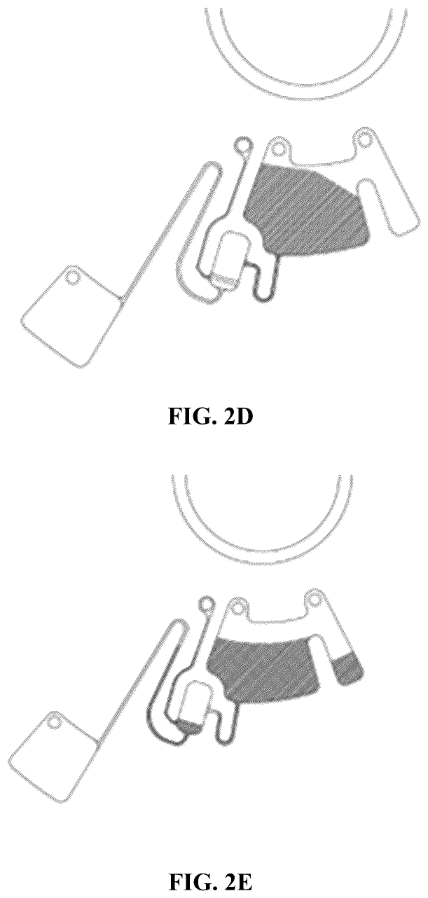

For instance, during a rotation at an initial rotation speed, the ballast chamber fills up with a liquid until the pneumatic pressure inside the ballast chamber matches the available centrifugal force as shown in FIG. 2A. The liquid position 144 reached inside the ballast chamber depends on various factors, such as the rotation speed, the liquid meniscus position on the upstream chamber 145, the u-channel outlet radial position 146, the air pressure inside the chamber, the ballast chamber 140 geometry, and/or the radial position of first ballast outlet 142. In some embodiments, at this initial rotation speed, these factors are tuned so that the liquid meniscus position on the siphon is radially outwards of the crest 132. This blocks the liquid flow and the structure acts as a valve in a closed position. By changing the rotation speed, the combined action of air pressure and centrifugal force inside the ballast chamber pushes the liquid inwards inside the siphon outlet, past the siphon crest, which then empties the liquid volume into the downstream chamber and thus causes the valve to “open”. Because the air pressure only increases after the liquid fills the vent inlet (corresponding to the first outlet 142 of the ballast chamber) instead of the siphon inlet (corresponding to the second outlet 143 of the ballast chamber), this allows for decoupling the total volume to be emptied from the volume used to generate air pressure in the ballast chamber.

In some embodiments, the vent port, siphon, ballast chamber, first channel, upstream chamber, U-channel, or any combination thereof are configured to allow emptying of the upstream chamber by decreasing the speed. For instance, as a non-limiting example, FIG. 2A illustrates an embodiment that allows for emptying when the speed is lowered after the initial rotation step (e.g., the priming speed is lower than the initial speed). In a specific implementation, the initial rotation speed may be about 2900 rpm and the priming speed may be about 2500 rpm. The upstream chamber liquid meniscus radius 145 may be at about 13.2 mm, the main chamber inlet radius 146 may be about 19 mm, the volume of the unvented portion of the main chamber 140 may be about 6 μL, the siphon crest 132 radius may be about 13 mm, the ballast chamber 140 may have a width of about 1.2 mm and a depth of about 0.6 mm, and the radius of the first outlet 142 of the main chamber t may be about 20.5 mm.

In some embodiments, the vent port, siphon, ballast chamber, first channel, upstream chamber, U-channel, or any combination thereof are configured to allow emptying of the upstream chamber by increasing the speed. For instance, as a non-limiting example, FIG. 2B illustrates an embodiment that allows for emptying when the speed is increased after the initial rotation step (e.g., the priming speed higher than the initial speed). In a specific implementation, the initial rotation speed may be about 3000 rpm and the priming speed may be about 4300 rpm. During the initial rotation speed, the upstream chamber liquid meniscus radius 145 may be at about 16 mm, the main chamber inlet radius 146 may be about 19 mm, the volume of the unvented portion of the main chamber 140 may be about 6 μL, the siphon crest radius 132 may be about 16.5 mm, the ballast chamber 140 may have a width of about 1.2 mm and a depth of about 0.6 mm, and the radius of the first outlet 142 of the main chamber may be about 20.5 mm. After accelerating to the higher priming speed the liquid meniscus on the upstream chamber will move outwards to position 148 and the liquid meniscus radius inside the main ballast will move inwards to position 147. This will cause the liquid meniscus position inside the siphon channel to move inwards past the siphon crest 132, which then empties the liquid volume into the downstream chamber and thus causes the valve to “open”

As a further non-limiting example, FIG. 2C illustrates an embodiment where the shapes or positions of some components of the device are different from those in FIGS. 2A and 2C. In a specific implementation, the initial rotation speed may be about 3500 rpm and the priming speed may be about 3100 rpm. The upstream chamber liquid meniscus radius 145 may be at about 27.5 mm, the main chamber inlet radius 146 may be about 36 mm, the volume of the unvented portion of the main chamber 140 may be about 1.8 μL, the siphon crest radius 132 may be about 31 mm, the ballast chamber may have a width of about 1.3 mm and a depth of about 0.8 mm, and the R start ballast may be about 41 mm.

Referring to FIGS. 2D-2G, there are shown liquid positions in a device with the siphon valve structure 110 during an operation in accordance with some embodiments of the present disclosure. FIG. 2D shows the liquid in an initial filling step. FIG. 2E shows the liquid in an initial rotation speed steady state, FIG. 2F shows the liquid in a priming step. FIG. 2D shows the liquid in an emptying step.

While FIGS. 2A, 2B and 2C illustrate the components with particular shapes and the corresponding paragraphs provide some specific values for some configuration/operation parameters, it should be noted that they are by way of examples and the present invention is not limited thereof. The device and/or the siphon valve structure can be configured with additional, optional or alternative components that may have different shapes and/or sizes, may be arranged at different positions, may be operated with different speeds, or the like.

The siphon valve structure of the present disclosure has a number of advantages. It allows for more flexibility in design and for more compact structures, specifically when the required volume for pneumatic control is smaller than the volume that needs to be extracted from the ballast chamber. It also provides size benefits because a large pressure can be generated by a small air chamber that is compressed with a small volume despite extracting a large volume of a fluid. Further, it allows multiple chambers to work at the same speeds/volumes despite having different volumes to be emptied. It can achieve higher pressures and permit a larger range of operation speeds. Furthermore, it allows to pack more features into the device (e.g., disk or cartridge) for more operations and/or be tuned to meet desired workflow requirements.

### Volume-Independent Reusable Pneumatic Siphon Valve

Many applications, such as immunoassays with particles that are sensitive to centrifugal force and processes with reactions that benefit from multiple washing steps, often require stopping the cartridge during certain workflow steps. However, existing valve designs, such as conventional pneumatic siphons, simple siphon metering valves and capillary siphon valves, are unsatisfactory for these applications. For instance, after initial emptying and stopping, conventional pneumatic siphons are hard to operate again using the same operation speeds as there is usually some residual volume left in the u-channel and inside the chamber which will enter the main chamber during the following ramp-up in speed. Due to the leftover liquid, the volume of the air chamber to be compressed will not be as well defined as in the initial condition, making conventional pneumatic siphons unreliable after the initial use. Simple siphon metering valves simply delay the liquid flow until it reaches a certain level and depend on upstream structures to control the liquid volume. Capillary siphon valves rely on capillary to wet and prime the siphon. Because capillary depends on the surface properties, capillary siphon valves are sensitive to the liquids to be processed and fabrication methods used to make the valves. They might also have different operation ranges after they are wetted with different liquids.

The present disclosure addresses these and/or other needs by providing a reusable siphon valve structure independent of the leftover fluid. It has a hybrid valving setup that allows for sequential liquid delivery while keeping a single metering structure that is more compact with high level of control and/or precision.

The general concept of the reusable siphon valve structure is similar or identical to the siphon valve structure 110 disclosed herein. Because the ballast chamber 140 is connected to the vent port 120, the ballast chamber is divided into two portions, one vented and one unvented. Thus, as long as the leftover fluid meniscus stays within the vented portion (e.g., does not exceed the radial position of the first outlet 142), the leftover liquid will not affect the pressure inside of the ballast chamber. This allows independent control of the pressure inside of the chamber and reuse of the siphon valve structure with high level of control and/or precision even when there is some leftover liquid.

In some embodiments, as in the one outlined in FIG. 2C, the ballast chamber 140 and the U-channel 170 are configured such that the second outlet 143 of the ballast chamber (corresponding to the inlet of the siphon) is located at the radially outermost position of the ballast chamber, and the volume inside the ballast chamber in an inwards position from outlet 142 is larger than a volume needed for overcoming the crest of the siphon, and in some embodiments, may be larger than the volume of the U-channel. This allows for multiple re-uses of the same valve structure and thus makes it much more efficient in terms of cartridge space for the same volume.

In some embodiments, operation speeds are tuned to ensure complete emptying of the upstream chamber. For instance, in some embodiments, the operation may include rotating the device at an initial speed to fill one or more chambers (e.g., the upstream chamber), changing the speed to empty one or more chambers, slowing down or stopping the rotation when needed, and repeating these steps for any desired number of times.

### Effective and Efficient Magnetic Particle Reaction Chamber

Magnetic particles can be used as components for reactions when functionalized properly. They are useful when there is a need for washing off non-bound reagents and sample interference from the specific bound analyte or reporters. If a centrifugal device is used to carry on such a reaction, there is the need of holding these particles while washing off the unwanted components. For a centrifugal device without any active magnetic elements, there is the need of an external magnetic field to hold the magnetic particles while washing them from unwanted components. If the external magnetic field does not follow the centrifugal device rotation movement for washing purposes, there is a need for specific features in the device to hold the magnetic particles. This feature needs to be able to both hold and release the magnetic particles when needed. The other challenge of using magnetic particles for reactions is the need to redisperse/homogenize the magnetic particles back into solution in order to have efficient reaction kinetics.

The present disclosure addresses these and/or other needs by providing a centrifugal device and method that can not only hold magnetic particles while washing a reaction chamber from all the unwanted components but also allows these particles to move back into the main reaction chamber and homogenize the mixture.

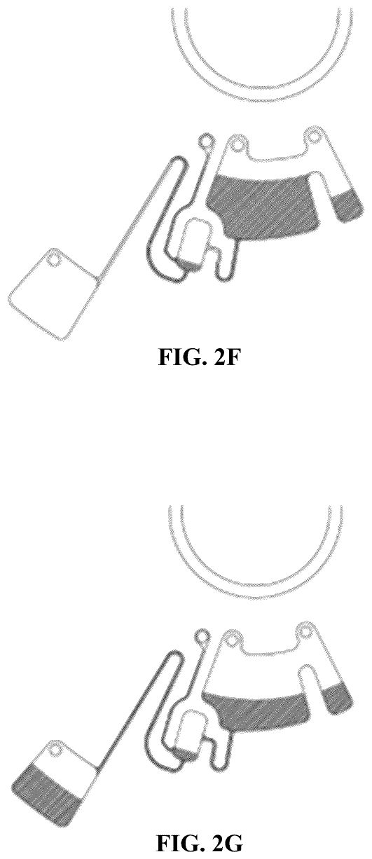

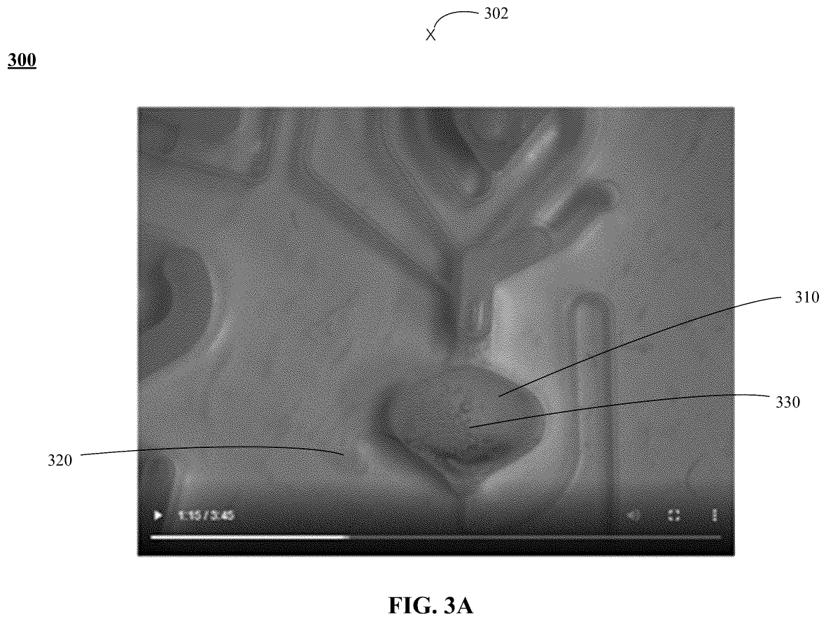

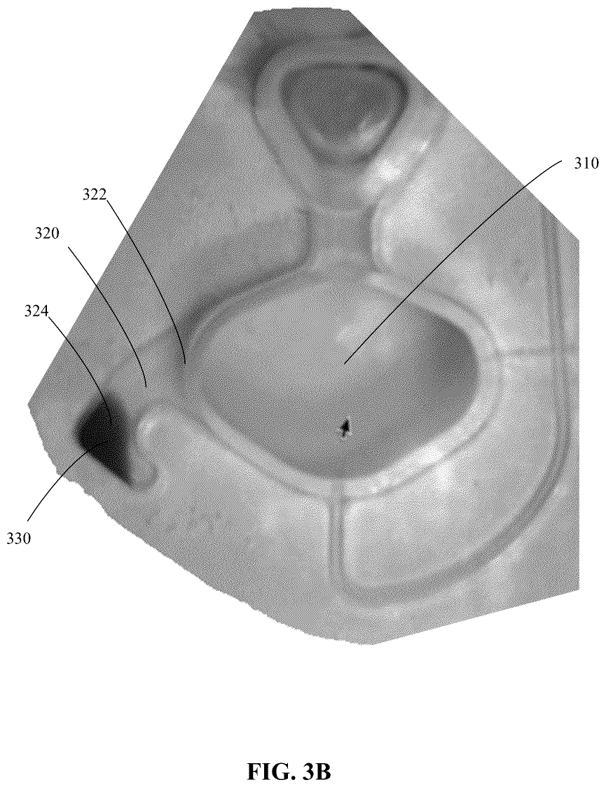

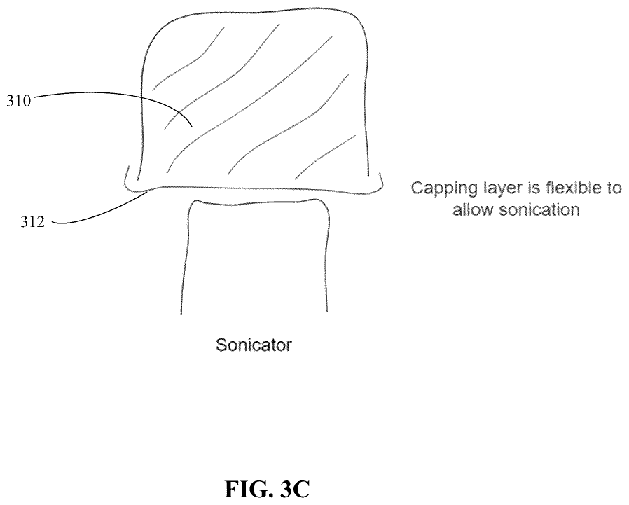

Referring to FIGS. 3A-3C, there is shown an exemplary device 300 in accordance with some embodiments of the present disclosure. The device is rotatable around a rotational axis 302. The device 300 includes a chamber 310, an appendix 320 and magnetic particles 330. The appendix 320 includes an entrance 322 connected to the chamber 310 and a trapping zone 324 radially outwards of the entrance with respect to the rotational axis. The magnetic particles are placed in the chamber or the appendix when the device is made. The chamber and appendix are configured such that the magnetic particles are movable between the chamber and the appendix by a magnet, positioning of the chamber relative to the magnet, rotation of the device, or any combination thereof. In some embodiments, the magnetic particles are magnetic nanoparticles.

In some embodiments, the chamber 310 includes a flexible capping layer 312, e.g., one of the chamber walls is made of a flexible material. The flexible capping layer is responsive to one or more sonification pulses to promote mixing of the magnetic particles with a fluid in the chamber. This allows, for example, the use of a sonicator probe to rapidly homogenize the reaction mixture without adding any additional features and/or reaction volume.

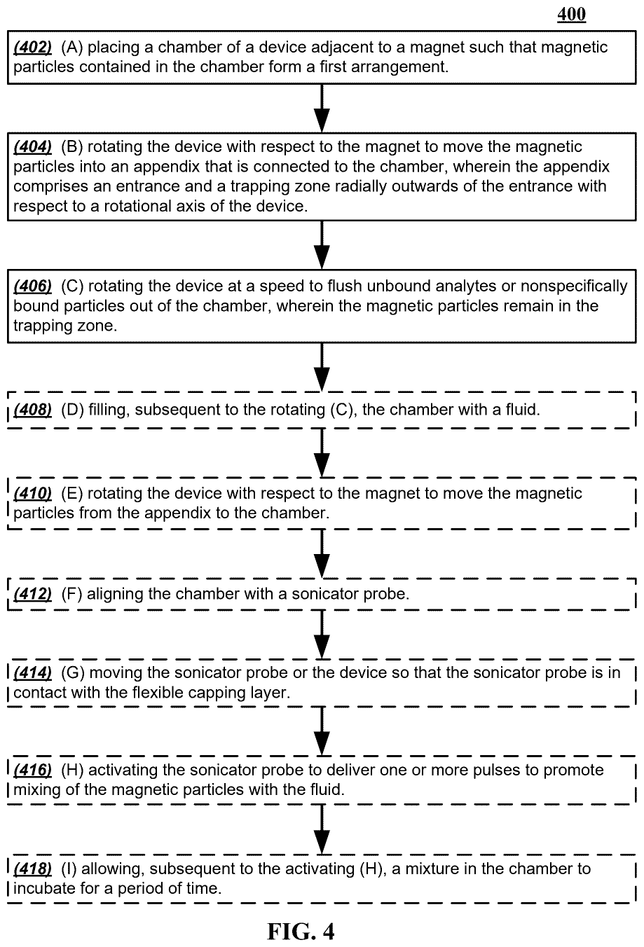

Referring to FIG. 4, there is shown a flowchart illustrating an exemplary method 400 for mixing a fluid in accordance with some embodiments of the present disclosure. In the flowchart, the preferred parts of the method are shown in solid line boxes, whereas additional, optional, or alternative parts of the method are shown in dashed line boxes. It should be noted that the processes disclosed herein and exemplified in the flowchart can be, but do not have to be, executed in full or in the order as they are presented.

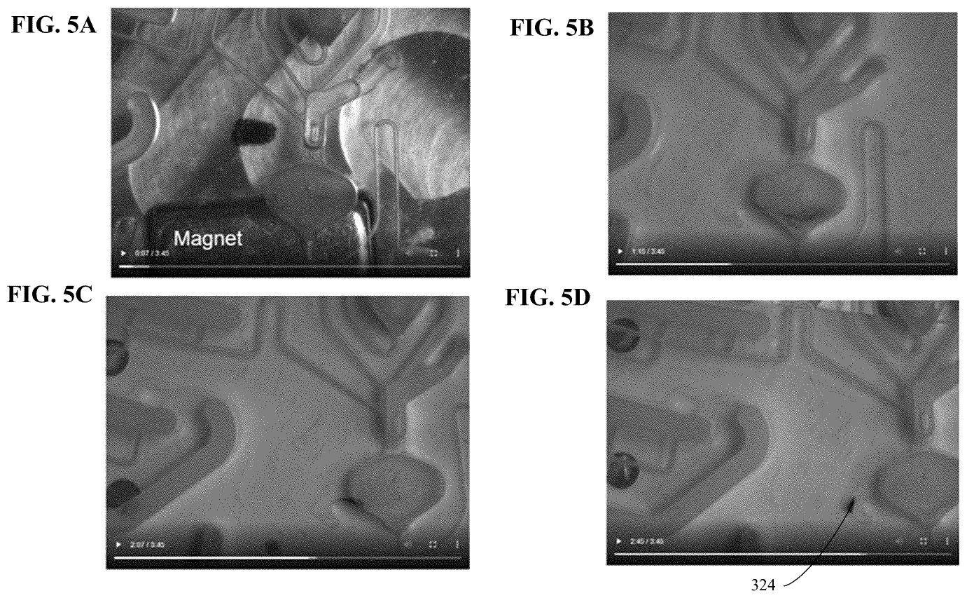

Referring to block 402, in some embodiments, the method includes (A) placing a chamber of a device adjacent to a magnet such that magnetic particles contained in the chamber form a first arrangement. For instance, in some embodiments, the method includes placing the chamber 310 of the device 300 adjacent to a magnet as shown in FIG. 5A. In some embodiments, the placing (A) is performed by rotating the device. Alternatively, in some exemplary embodiments, the placing (A) is performed by moving the magnet, or by moving the magnet and the device. In some embodiments, the magnet produces a magnetic field that is strongest in a middle portion of the chamber.

Referring to block 404, in some embodiments, the method also includes (B) rotating the device in a first direction with respect to the magnet to move the magnetic particles into an appendix that is connected to the chamber, wherein the appendix includes an entrance and a trapping zone radially outwards of the entrance with respect to a rotational axis of the device. For instance, as shown in FIGS. 5B and 5C, as the device rotates respect to the magnet, the magnetic particles move from the chamber 310 into the appendix 320 that is connected to the chamber. The rotation of the device can be performed continuously (e.g., rotating smoothly from one position to another position without no stops) or intermittently (e.g., at a set of angular positions).

Referring to block 406, in some embodiments, the method further includes (C) rotating the device at a speed to flush unbound analytes or nonspecifically bound particles out of the chamber. the magnetic particles remain in the trapping zone. For instance, as shown in FIGS. 5C and 5D, as the device rotates at a speed to flush unbound analytes or nonspecifically bound particles out of the chamber, the magnetic particles remain there during the flush. In some embodiments, the magnetic particles will retain in the trapping zone as the device rotates at high speeds and any liquid in the chamber can overflow to another reservoir without any magnetic particle loss.

Referring to block 408, in some embodiments, the method includes (D) filling, subsequent to the rotating (C), the chamber with a fluid.

Referring to block 410, in some embodiments, the method includes (E) rotating the device with respect to the magnet to move the magnetic particles from the appendix to the chamber. The rotation of the device can be performed continuously or intermittently (e.g., at a set of angular positions).

Referring to block 412, in some embodiments, the method includes (F) aligning the chamber with a sonicator probe. In some embodiments, the aligning (F) is achieved by rotating the device.

Referring to block 414, in some embodiments, the method includes (G) moving the sonicator probe or the device so that the sonicator probe is in contact with the flexible capping layer.

Referring to block 416, in some embodiments, the method includes (H) activating the sonicator probe to deliver one or more pulses to promote mixing of the magnetic particles with the fluid.

Referring to block 418, in some embodiments, the method includes (I) allowing, subsequent to the activating (H), a mixture in the chamber to incubate for a period of time.

In some embodiments, the aligning (F), moving (G) and activating (H) are performed prior to the placing (A). In some embodiments, the aligning (F), moving (G) and activating (H) are performed subsequent to the rotating (E). In some embodiments, the relative movement between the magnet and the chamber is made by moving the magnet, the device, or both. In some embodiments, the method includes repeating any one of the steps disclosed above.

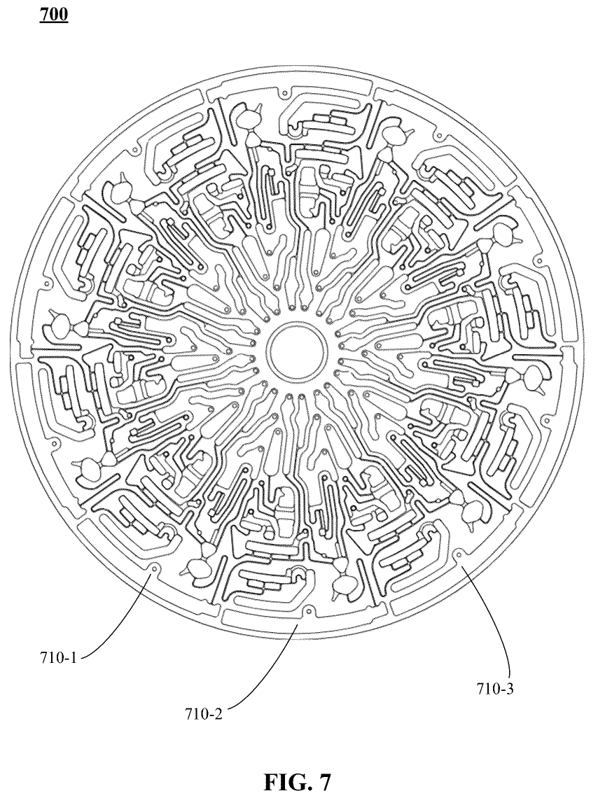

Referring to FIG. 7, there is shown a device 700 (e.g., a disc) in accordance with an alternative exemplary embodiment of the present disclosure. In some embodiments, the device 700 (e.g., the disc) includes a plurality of units, such as units 710-1, 710-2, 710-3, arranged circumferentially. In some embodiments, the device 700 includes 2, 3, 4, 5, 6, 7, 8, 9, 10, or more than 10 units. In some embodiments, a unit 710 includes one or more features/components/devices (e.g., the siphon valve structure 110) disclosed herein. In some embodiments, each unit 710 includes one or more features/components/devices (e.g., the siphon valve structure 110) disclosed herein. In some embodiments, each unit is identical to another unit in the plurality of units. In some embodiments, at least one unit is different than the other unit(s) in the plurality of units.

### Exemplary Workflow

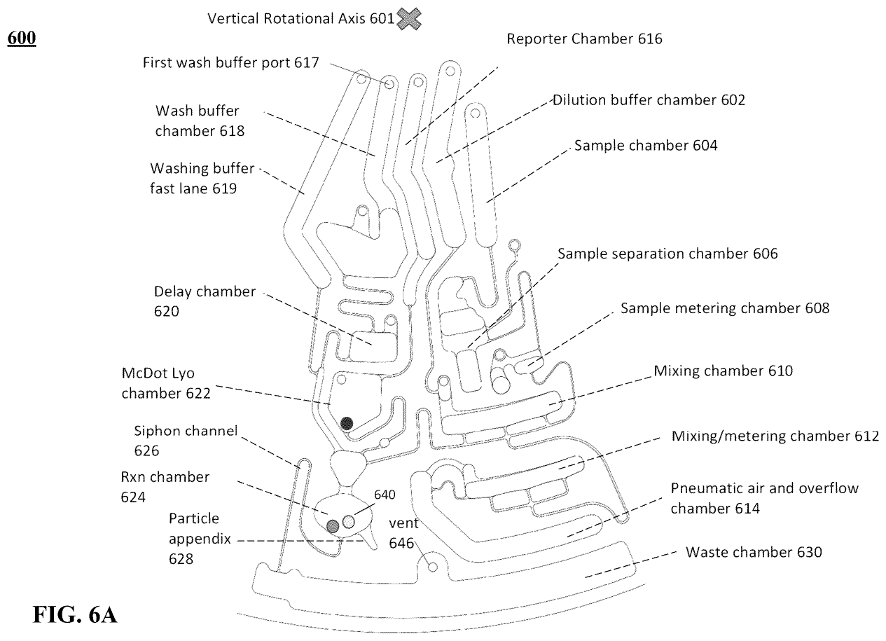

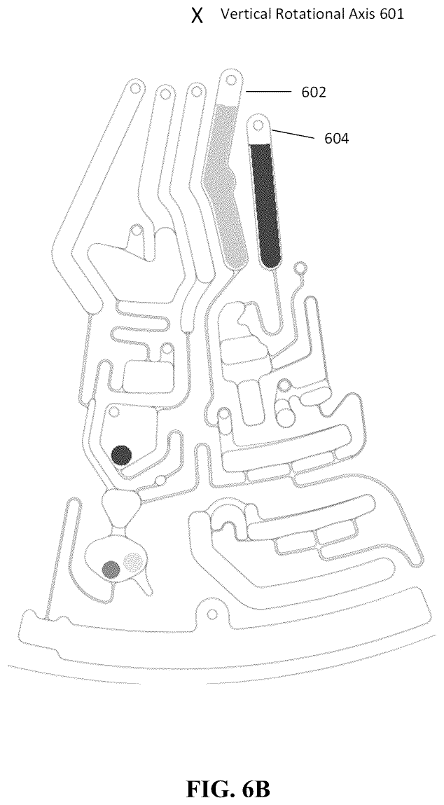

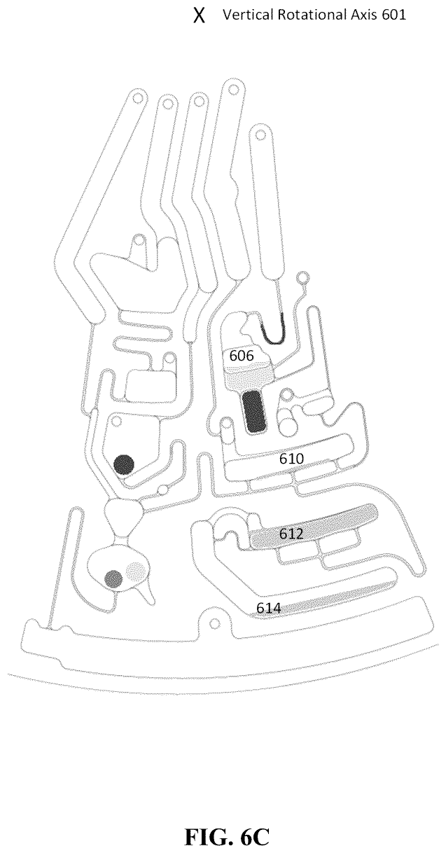

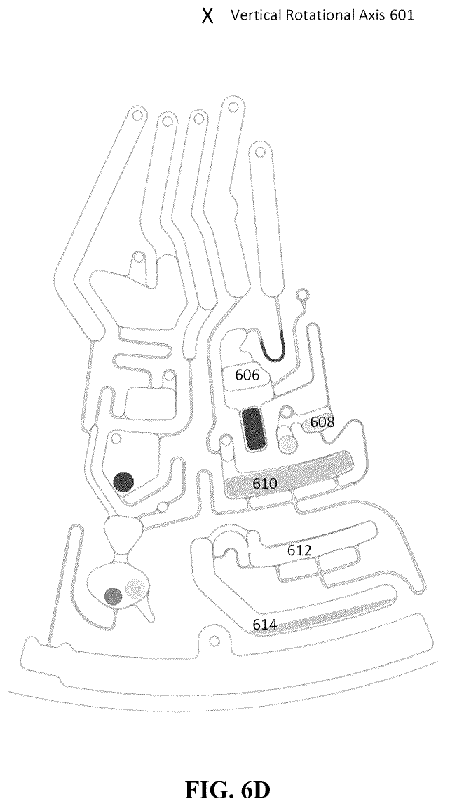

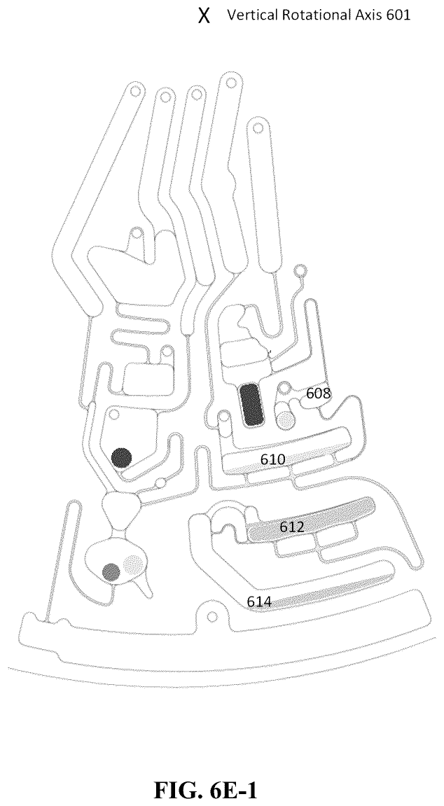

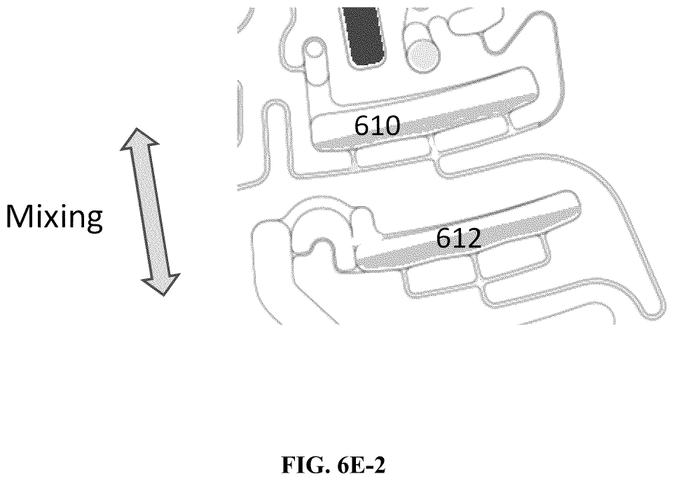

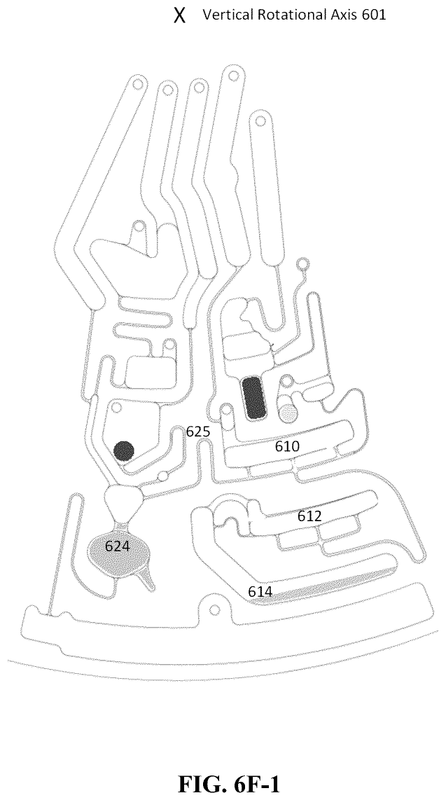

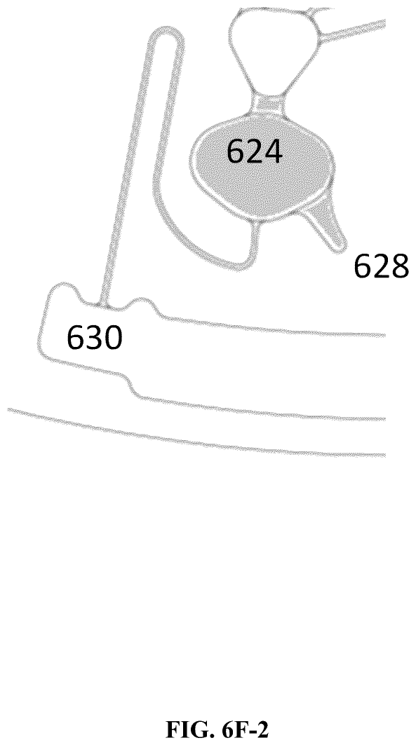

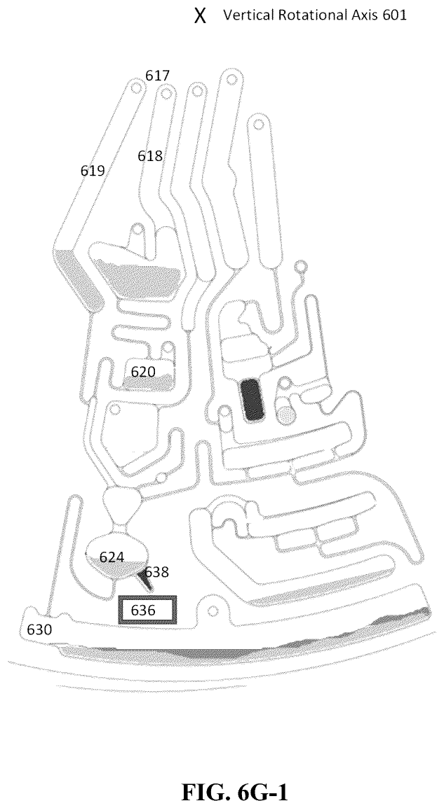

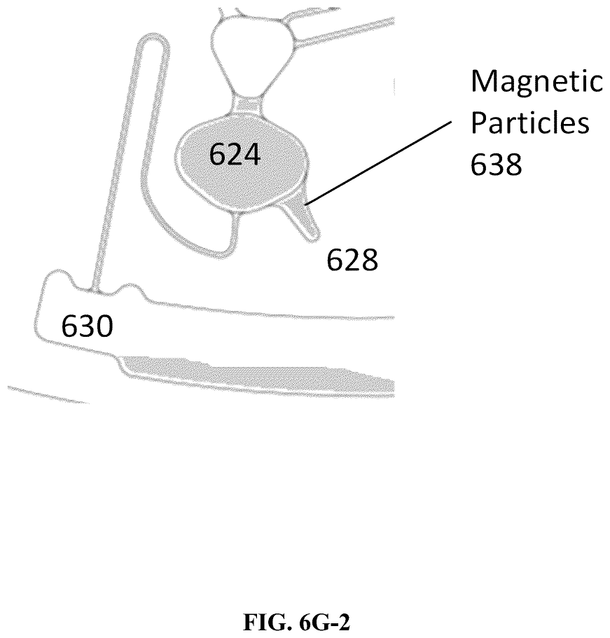

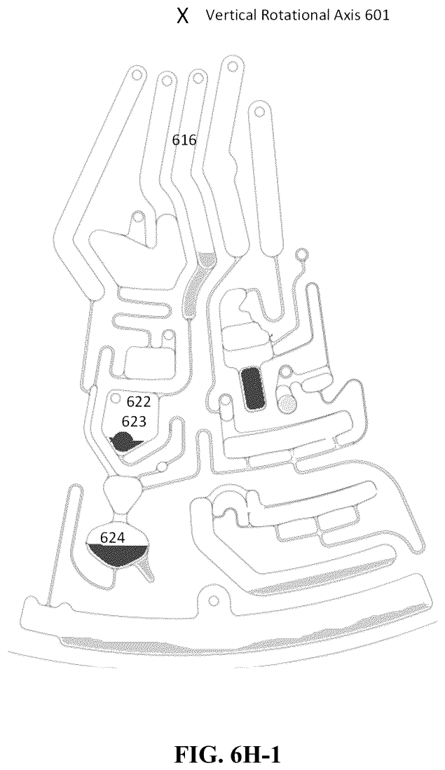

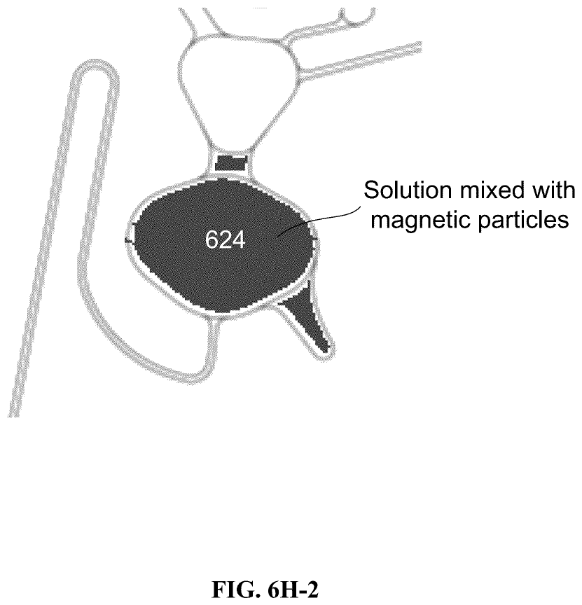

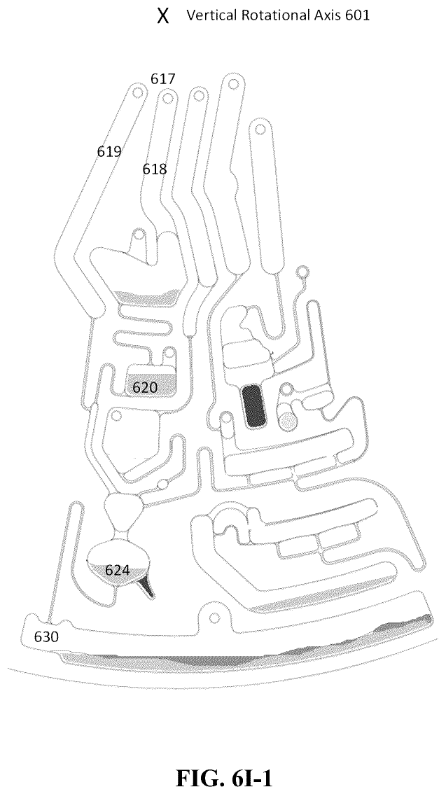

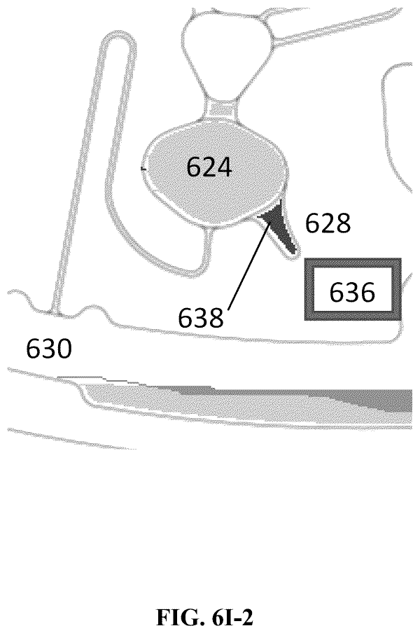

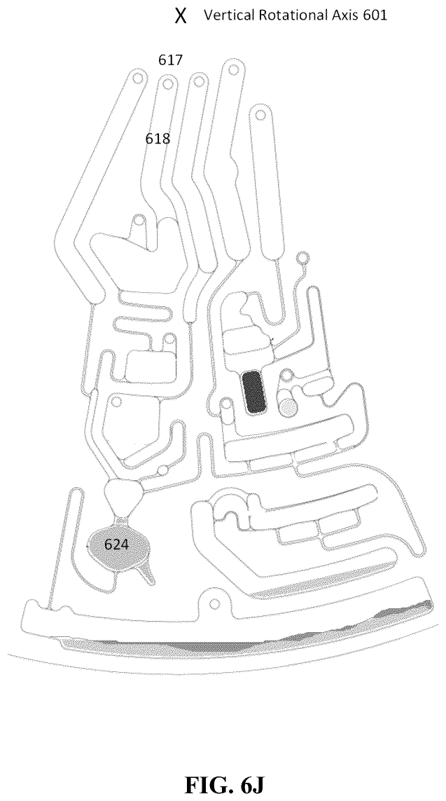

FIGS. 6A-6J are schematic diagrams collectively illustrating an exemplary workflow in accordance with some exemplary embodiments of the present disclosure. While specific specimens (e.g., whole blood) are used in describing the workflow, it should be noted that the present disclosure is not limited thereto. Other samples, such as those disclosed herein, can be used. In addition, the workflow can be automated.

Referring to FIG. 6A, there is shown a device (e.g., a disc) 600 in accordance with some exemplary embodiments of the present disclosure. For clarity, only a portion of the device is shown. The device 600 is rotatable about a rotational axis, such as the vertical rotational axis 601. In some implementations, the device 600 may be rotated, during one or more processes, at a speed of at least about 1000 rpm, at least about 1200 rpm, at least about 1400 rpm, at least about 1600 rpm, at least about 1800 rpm, at least about 2000 rpm, at least about 2200 rpm, at least about 2400 rpm, at least about 2600 rpm, at least about 2800 rpm, at least about 2900 rpm, at least about 3000 rpm, at least about 3500 rpm, at least about 4000 rpm, at least about 4500 rpm, at least about 5000 rpm, at least about 5500 rpm, at least about 6000 rpm, at least about 6500 rpm, or at least about 7000 rpm. In some implementations, the device 600 may be rotated, during one or more processes, at a speed of at most about 500 rpm, at most about 600 rpm, at most about 700 rpm, at most about 800 rpm, at most about 900 rpm, at most about 1000 rpm, at most about 1200 rpm, at most about 1400 rpm, at most about 1600 rpm, at most about 1800 rpm, at most about 2000 rpm, at most about 2200 rpm, at most about 2400 rpm, at most about 2600 rpm, at most about 2800 rpm, at most about 2900 rpm, at most about 3000 rpm, at most about 3500 rpm, at most about 4000 rpm, at most about 4500 rpm, or at most about 5000 rpm.

The device 600 includes one or more ports, one or more chambers, one or more lanes, and one or more channels. For instance, in the illustrated embodiments, the device 600 includes a dilution buffer chamber 602, a sample chamber 604, a sample separation chamber 606, a sample metering chamber 608, a mixing chamber 610, a mixing/metering chamber 612, a pneumatic air and overflow chamber 614, a reporter chamber 616, a first wash buffer port 617, a wash buffer chamber 618 (also termed wash buffer slow lane 618), a washing buffer fast lane 619, a delay chamber 620, a McDot Lyo chamber 622, a siphon channel 626, a reaction (Rxn) chamber 624, a particle appendix 628, a waste chamber 630 and vent 646. In some implementations, the Rxn chamber 624 includes or houses lyophilized reagent beads 640. In some implementations, the lyophilized reagent beads 640 include magnetic particles and antibodies. While the device 600 is illustrated with specific components (e.g., specific chambers, channels), it should be noted that this is by way of example and is non-limiting. In some implementations, the device 600 may not include one or more of these specific components. In some implementations, the device 600 may include additional or alternative components such as those disclosed herein.

The device 600 can be used to perform a variety of immunoassays. Examples of typical immunoassays that can be run in the device 600 include but are not limited to free thyroxine hormone (T4), thyroid stimulating hormone (TSH), b-type natriuretic peptide BNP such as N-terminal pro BNP, C-Reactive Protein (CRP), vitamin D, prostate-specific antigen (PSA), ferritin, D-dimmer, testosterone, and troponin, or a combination thereof in the sample.

Referring to FIG. 6B, there is illustrated a sample and buffer loading process in accordance with some exemplary embodiments of the present disclosure. In this process, a sample (e.g., whole blood) is loaded into the sample chamber 604, and a dilution buffer is loaded into the dilution buffer chamber 602. In some implementations, the sample is whole blood sample. In some implementations, the buffer is TBST dilution buffer, e.g., a mixture of tris-buffered saline (TBS) (a buffer solution) and Polysorbate 20 (a polysorbate-type nonionic surfactant).

Referring to FIG. 6C, there is illustrated a spinning process in accordance with some exemplary embodiments of the present disclosure. In some implementations, the device 600 is spun at high speed around the vertical rotational axis 601. In some implementations, the sample (e.g., the whole blood sample) moves to the sample separation chamber 606. As the device 600 spins, the whole blood sample separates into plasma and cellular fractions. The dilution buffer moves to the mixing chamber 610 and the mixing/metering chamber 612. In addition, the dilution buffer is metered in the mixing/metering chamber 612. If there is excess dilution buffer, the excess dilution buffer overflows into the pneumatic air and overflow chamber 614.

Referring to FIG. 6C, there is illustrated a sample priming process in accordance with some exemplary embodiments of the present disclosure. In some implementations, rotation of the device 600 is slowed down, which allows plasma fraction of the sample to flow from the sample separation chamber 606 to the sample metering chamber 608. When rotation of the device 600 slows, the TBST dilution buffer moves from the mixing/metering chamber 612 to the mixing chamber 610 as trapped air in the pneumatic air and overflow chamber 614 expands, pushing the TBST dilution buffer from the mixing/metering chamber 612 into the mixing chamber 610.

In some implementations, with respect to timing, when rotation of the device 600 slows, the TBST dilution buffer flows from the mixing/metering chamber 612 to the mixing chamber 610 before plasma flows from the sample separation chamber 606 to the sample metering chamber 608. In this way, plasma is blocked from flowing towards the mixing chamber 610, allowing it to be metered in the sample metering chamber 608.

Referring to FIGS. 6E-1 and 6E-2, there is illustrated a sample injection and mixing process in accordance with some exemplary embodiments of the present disclosure. In some implementations, by increasing the rotation speed of the device 600, metered plasma flows from the sample metering chamber 608 to the mixing chamber 610. Metered plasma is mixed with the TBST dilution buffer by speeding up and slowing down the rotation of the device 600, which causes trapped air in the pneumatic air and overflow chamber 614 to expand and contract, thereby pushing the plasma/TBST dilution buffer mixture back and forth.

Referring to FIGS. 6F-1 and 6F-2, there is illustrated a lyophilized bead reconstitution and pulldown process in accordance with some exemplary embodiments of the present disclosure. In some implementations, the rotation speed of the device 600 is decreased. This causes trapped gas in the pneumatic air and overflow chamber 614 to expand, thereby pushing the plasma/dilution buffer mixture from the mixing/metering chamber 612 and mixing chamber 610, through the siphon 625, and into the reaction (Rxn) chamber 624.

In some implementations, magnetic particles and antibodies in the lyophilized reagent beads 640 (e.g., as illustrated in FIG. 6A) are dissolved during this process.

In some implementations, additionally or optionally, a sonicator probe (e.g., as illustrated in FIG. 3C) makes contact with the Rxn chamber 624 to mix its contents. For instance, in some implementations, a sonicator probe is used to rapidly homogenize the reaction mixture.

Referring to FIGS. 6G-1 and 6G-2 together with FIGS. 6F-1 and 6F-2, there is illustrated a wash process (e.g., a first wash) in accordance with some exemplary embodiments of the present disclosure. In some implementations, magnetic particles 638 can be isolated in the particle appendix 628 by placing a magnet 636 in close proximity to the particle appendix 628. In some implementations, a wash buffer is added to the wash buffer fast lane 619 and wash buffer chamber 618 (also called buffer slow lane 618). The device 600 is spun, causing the wash buffer in the wash buffer fast lane 619 to move to the Rxn chamber 624, combine with the diluted plasma mixture and then move to the waste chamber 630. The wash buffer in the wash buffer slow lane 618 is held in the delay structure 620 during this time and eventually flows into the Rxn chamber 624 and the waste chamber 630. In some implementations, during this process, the magnetic particles 638 stay in the particle appendix 628.

Referring to FIGS. 6H-1 and 6H-2, there is illustrated a reporter lyophilized bead reconstitution and incubation process in accordance with some exemplary embodiments of the present disclosure. In some implementations, the buffer is added to the reporter chamber 616. The device 600 is spun, forcing the buffer to flow from the reporter chamber 616 into the reporter lyo chamber 622, dissolving the reporter lyophilized bead 623, then flowing into the Rxn chamber 624. In some implementations, the device 600 stops spinning and magnetic particles 638, as illustrated in FIG. 6G, are resuspended in the solution in the Rxn chamber 624, as illustrated in FIG. 6H-2. In some implementations, static magnet 636 is used to move the magnetic particles 638 back into the Rxn chamber 624, and/or a sonicator probe is used to achieve a uniform suspension.

Referring to FIGS. 6I-1 and 61-2, there is illustrated a particles pulldown and wash process in accordance with some exemplary embodiments of the present disclosure. In some implementations, after incubation, the magnet 636 is used to move the magnetic particles and bound reporter particles 638 into the particle appendix 628. In some implementations, wash buffer is added to the wash buffer fast lane 619 and the wash buffer slow lane 618. In some implementations, the device 600 is spun, causing the wash buffer in the wash buffer fast lane to move to the Rxn chamber 624, combine with the reaction mixture and then move to the waste chamber 630. The wash buffer in the wash buffer slow lane is held in the delay structure 620 during this time and eventually flows into the Rxn chamber 624 and the waste chamber 630. In some implementations, during this process, magnetic particles 638 stay in the particle appendix 628.

Referring to FIG. 6J, there is illustrated resuspended particles and readout process in accordance with some exemplary embodiments of the present disclosure. In some implementations, buffer is added to the wash buffer chamber 618. The device 600 is spun, transferring the buffer from the wash buffer chamber 618 to the Rxn chamber 624. Magnetic particles bound to reporter particles 638, as illustrated in FIGS. 61-1 and 61-2, are resuspended and mixed with the TBST buffer in the Rxn chamber 624, for instance, using a sonicator probe. In some implementations, the Rxn chamber 624 is then aligned under a readout sensor for result detection.

The devices and methods disclosed herein can be used in a variety of applications including but not limited to clinical chemistry, immunoassays and hematology. Examples of clinical chemistry, immunoassays and/or hematology are disclosed in WO2018/119437,WO2018/140719, WO2022/029731, and WO 2022/029732, the content of each application is hereby incorporated by reference in its entirety. The devices and methods disclosed herein may be operated or performed by a system similar to those disclosed in U.S. patent application Ser. No. 17/371,746, the content of which is hereby incorporated by reference in its entirety.

### Illustration of Subject Technology as Clauses

Various examples of aspects of the disclosure are described as numbered clauses (1, 2, 3, etc.) for convenience. These are provided as examples, and do not limit the subject technology.

Clause 1. A device comprising: a rotational axis; a vent port; a siphon having a crest positioned radially outwards of the vent port with respect to the rotational axis; and a ballast chamber having a first outlet connected to the vent port and a second outlet connected to an inlet of the siphon, wherein the first outlet of the ballast chamber is positioned radially inwards of the second outlet of the ballast chamber and radially outwards of the crest of the siphon with respect to the rotational axis, thereby dividing the ballast chamber into an unvented ballast portion radially inwards of the first outlet and a vented ballast portion radially outwards of the first outlet.

Clause 2. The device of Clause 1, wherein the second outlet of the ballast chamber is formed at or adjacent to a radially outermost location of the ballast chamber.

Clause 3. The device of any preceding Clause, further comprising: a first channel connecting the first outlet of the ballast chamber to the vent port.

Clause 4. The device of any preceding Clause, further comprising: an upstream chamber connected to the ballast chamber.

Clause 5. The device of Clause 4, wherein the ballast chamber comprises an inlet at the unvented ballast portion, and the upstream chamber is connected to the inlet at the unvented ballast portion of the ballast chamber.

Clause 6. The device of any one of Clauses 4-5, wherein: the upstream chamber comprises an outlet connected to the ballast chamber; and the crest of the siphon and the vent port are radially inwards of the outlet of the upstream chamber.

Clause 7. The device of Clause 6, wherein the outlet of the upstream chamber is formed at a radially outermost location of the upstream chamber.

Clause 8. The device of any one of Clauses 4-7, further comprising: a U-channel connecting the ballast chamber to the upstream chamber.

Clause 9. The device of Clause 8, wherein a volume inside the ballast chamber in an inwards position from the first outlet is larger than a volume needed for overcoming the crest of the siphon.

Clause 10. The device of any preceding Clause, further comprising: a downstream chamber connected to an outlet of the siphon.

Clause 11. The device of Clause 10, wherein the downstream chamber is positioned radially outwards of the second outlet.

Clause 12. The device of any preceding Clause, wherein the vent port, siphon, ballast chamber, first channel, upstream chamber, U-channel, or any combination thereof are configured to allow initial loading of a fluid by rotating the device at a speed that causes the fluid to fill the ballast chamber and the siphon, forming a first meniscus inside of the ballast chamber that is radially inwards of the first outlet and a second meniscus inside of the siphon that is radially outwards of the crest of the siphon.

Clause 13. The device of Clause 12, wherein the vent port, siphon, ballast chamber, first channel, upstream chamber, U-channel, or any combination thereof are configured to allow emptying of the upstream chamber by decreasing the speed.

Clause 14. The device of Clause 12, wherein the vent port, siphon, ballast chamber, first channel, upstream chamber, U-channel, or any combination thereof are configured to allow emptying of the upstream chamber by increasing the speed.

Clause 15. The device of any one of Clauses 13-14, wherein the vent port, siphon, ballast chamber, first channel, upstream chamber, U-channel, or any combination thereof are configured to allow complete emptying of the upstream chamber.

Clause 16. A device comprising: a rotational axis; a chamber; an appendix comprising an entrance connected to the chamber and a trapping zone radially outwards of the entrance with respect to the rotational axis; and magnetic particles movable between the chamber and the appendix by a magnet, positioning of the chamber relative to the magnet, rotation of the device, or any combination thereof.

Clause 17. The device of Clause 16, wherein the chamber comprises a flexible capping layer responsive to one or more sonification pulses to promote mixing of the magnetic particles with a fluid in the chamber.

Clause 18. The device of any one of Clauses 16-17, wherein the magnetic particles are magnetic nanoparticles.

Clause 19. A method comprising: (A) placing a chamber of a device adjacent to a magnet such that magnetic particles contained in the chamber form a first arrangement; (B) rotating the device in respect to the magnet to move the magnetic particles into an appendix that is connected to the chamber, wherein the appendix comprises an entrance and a trapping zone radially outwards of the entrance with respect to a rotational axis of the device; and (C) rotating the device at a speed to flush unbound analytes or nonspecifically bound particles out of the chamber, wherein the magnetic particles remain in the trapping zone.

Clause 20. The method of Clause 19, wherein the placing (A) is performed by rotating the device.

Clause 21. The method of any one of Clauses 19-20, wherein the magnet produces a magnetic field that is strongest in a middle portion of the chamber.

Clause 22. The method of any one of Clauses 19-21, wherein the rotating (B) is performed continuously.

Clause 23. The method of any one of Clauses 19-21, wherein the rotating (B) is performed intermittently.

Clause 24. The method of any one of Clauses 19-22, further comprising: (D) filling, subsequent to the rotating (C), the chamber with a fluid; and (E) rotating the device in respect to the magnet to move the magnetic particles from the appendix to the chamber.

Clause 25. The method of Clause 24, wherein the rotating (E) is performed continuously.

Clause 26. The method of Clause 24, wherein the rotating (E) is performed intermittently.

Clause 27. The method of any one of Clauses 19-26, wherein the chamber comprises a flexible capping layer, the method further comprising: (F) aligning the chamber with a sonicator probe; (G) moving the sonicator probe or the device so that the sonicator probe is in contact with the flexible capping layer; and (H) activating the sonicator probe to deliver one or more pulses to promote mixing of the magnetic particles with the fluid.

Clause 28. The method of Clause 27, wherein the aligning (F) is achieved by rotating the device.

Clause 29. The method of any one of Clauses 27-28, wherein the aligning (F), moving (G) and activating (H) are performed prior to the placing (A).

Clause 30. The method of any one of Clauses 27-28, wherein the aligning (F), moving (G) and activating (H) are performed subsequent to the rotating (E).

Clause 31. The method of any one of Clauses 27-30, further comprising: (I) allowing, subsequent to the activating (H), a mixture in the chamber to incubate for a period of time.

Clause 32. A system for operating the device or performing the method of any preceding Clause.

### TERMINOLOGIES AND REFERENCES CITED

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, “inward” or “outward” and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “include”, “includes”, “including”, “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “i^{th}” denotation, the reference number refers to a generic component, set, or embodiment. For instance, a “unit i” refers to the i^{th} unit in a plurality of units.

All references cited herein are incorporated herein by reference in their entirety and for all purposes to the same extent as if each individual publication or patent or patent application was specifically and individually indicated to be incorporated by reference in its entirety for all purposes.

1. A device comprising:
a rotational axis;
a vent port;
a siphon having a crest positioned radially outwards of either the vent port or any portion of a channel connected to the vent port with respect to the rotational axis; and
a ballast chamber having a first outlet connected to the vent port and a second outlet connected to an inlet of the siphon,
wherein the first outlet of the ballast chamber is positioned radially inwards of the second outlet of the ballast chamber and radially outwards of the crest of the siphon with respect to the rotational axis, thereby dividing the ballast chamber into an unvented ballast portion radially inwards of the first outlet and a vented portion radially outwards of the first outlet,
wherein the second outlet of the ballast chamber is formed at or adjacent to a radially outermost location of the ballast chamber.

2. (canceled)

3. The device of claim 1, further comprising:
a first channel connecting the first outlet of the ballast chamber to the vent port.

4. The device of claim 1, further comprising:
an upstream chamber connected to the ballast chamber.

5. The device of claim 4, wherein the ballast chamber comprises an inlet at the unvented ballast portion, and the upstream chamber is connected to the inlet at the unvented ballast portion of the ballast chamber.

6. The device of claim 4, wherein:
the upstream chamber comprises an outlet connected to the ballast chamber; and
optionally, the crest of the siphon and the vent port are radially inwards of the outlet of the upstream chamber.

7. The device of claim 6, wherein the outlet of the upstream chamber is formed at a radially outermost location of the upstream chamber.

8. The device of claim 4, further comprising:
a U-channel connecting the ballast chamber to the upstream chamber.

9. The device of claim 8, wherein a volume inside the ballast chamber in an inwards position of the first outlet is larger than a volume needed for overcoming the crest of the siphon.

10. The device of claim 1, further comprising:
a downstream chamber connected to an outlet of the siphon.

11. The device of claim 10, wherein the downstream chamber is positioned radially outwards of the second outlet.

12-24. (canceled)
